(19) United States
(12) Patent Application Publication
(10) Pub. No.: US 2026/0113576 A1
(43) Pub. Date: Apr. 23, 2026

(54) STIFFNESS REDUCTION FOR AUDIO TRANSDUCERS

(71) Applicant: Apple Inc., Cupertino, CA (US)

(72) Inventors: Yazhou CHEN, Suzhou (CN); Christopher WILK, Los Gatos, CA (US); Chunchuan CUI, Suzhou (CN); Onur I. ILKORUR, Santa Clara, CA (US); Stuart M. NEVILL, Los Gatos, CA (US)

(21) Appl. No.: 19/322,507

(22) Filed: Sep. 8, 2025

(30) Foreign Application Priority Data
Oct. 21, 2024 (CN) 202411471106.X

(51) Int. Cl. H04R 9/02

(52) U.S. Cl. CPC H04R 9/025

(57) ABSTRACT

Aspects of the subject technology relate to stiffness reduction for audio transducers, such as speakers. Stiffness reduction can be provided using one or springs disposed at least partially within a cavity in a magnet of the audio transducer. The magnet may be a center magnet, around which a voice coil of the speaker extends.

### CROSS REFERENCE TO RELATED APPLICATION(S)

The present application claims priority to Chinese Patent Application No. CN202411471106.X filed on Oct. 21, 2024, entitled “STIFFNESS REDUCTION FOR AUDIO TRANSDUCERS”, the entirety of which is incorporated herein by reference.

### TECHNICAL FIELD

The present description relates generally to audio transducers, including, for example, stiffness reduction for audio transducers.

### BACKGROUND

Audio transducers, such as speakers, typically include a front volume and a back volume separated by membrane that is movably suspended by a surround.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates a perspective view of an example electronic device having a speaker in accordance with various aspects of the subject technology.

FIG. 2 illustrates a cross-sectional view of a portion of an example electronic device having a speaker in accordance with various aspects of the subject technology.

FIG. 3 illustrates a top view of a portion of an example speaker in accordance with various aspects of the subject technology.

FIG. 4 illustrates a perspective bottom view of a speaker in accordance with various aspects of the subject technology.

FIG. 5 illustrates a top view of another example speaker in accordance with various aspects of the subject technology.

FIG. 6 illustrates a top perspective view of the speaker of FIG. 5 with a diaphragm removed in accordance with various aspects of the subject technology.

FIG. 7 illustrates a cross-sectional side view of a portion of an implementation of the speaker of FIG. 5 in accordance with various aspects of the subject technology.

FIGS. 8A-8E illustrates various examples of springs that may be included in a speaker for stiffness reduction in accordance with various aspects of the subject technology.

FIG. 9 illustrates a top view of a circular spring that may be disposed at least partially within a cavity in a magnet of an audio transducer for stiffness reduction in accordance with various aspects of the subject technology.

FIG. 10 illustrates a cross-sectional side view of a portion of another implementation of the speaker of FIG. 5 in accordance with various aspects of the subject technology.

FIG. 11 illustrates a cross-sectional side view of a portion of yet another implementation of the speaker of FIG. 5 in accordance with various aspects of the subject technology.

FIG. 12 illustrates a cross-sectional side view of a portion of still another implementation of the speaker of FIG. 5 in accordance with various aspects of the subject technology.

FIG. 13 illustrates a cross-sectional side view of a portion of a further implementation of the speaker of FIG. 5 in accordance with various aspects of the subject technology.

FIG. 14 illustrates a flow chart of illustrative operations that may be performed for operating an audio transducer in accordance with various aspects of the subject technology.

FIG. 15 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Electronic devices such as a mobile phones, smartphones, portable music players, tablet computers, laptop computers, wearable devices such as smart watches, headphones, earbuds, head mountable devices, other wearable devices, desktop computers, smart speakers, wireless speakers, and the like, often include one or more audio transducers such as a speaker for generating sound, and/or a microphone for receiving sound input. For example, microspeakers may be included in various compact electronic devices, such as portable electronic devices and/or wearable electronic devices such as headphones or earbuds. For example, in one or more implementations, a microspeaker may have a largest dimension of less than between ten millimeters (mm) and one hundred mm (e.g., within a size range of from ten mm to twenty mm or twenty mm to fifty mm, in some implementations).

A back volume of a speaker having a movable membrane or diaphragm (e.g., also referred to as a dome or a stiffener) for generating sound is often a substantially sealed volume. Air that is trapped within the sealed volume can effectively act as an air spring that resists movement of the membrane or diaphragm. This air spring can effectively increase a stiffness with which the diaphragm is moveably suspended. Reducing the size of the back volume can also result in an increase in the stiffness with which the membrane is moveably suspended. Increased stiffness can reduce the ability of the speaker to generate relatively low frequency sounds in some cases.

Aspects of the subject technology can help to reduce the stiffness with which a speaker membrane is moveably suspended, even in implementations in compact devices with small back volumes, such as in microspeakers.

In accordance with aspects of the subject disclosure, stiffness reduction for an audio transducer, such as a speaker (e.g., a microspeaker), is provided using one or more springs mounted at least partially within a cavity in a central portion of a magnet of the speaker. The cavity may be a hole (e.g., a through-hole) or a pocket formed at or around a center of the magnet. The spring may be coupled to the diaphragm of the speaker and biased to push the diaphragm away from the back volume and toward the front volume. In this way, the spring may provide a negative stiffness that effectively cancels a portion of the stiffness generated by trapped air in the back volume.

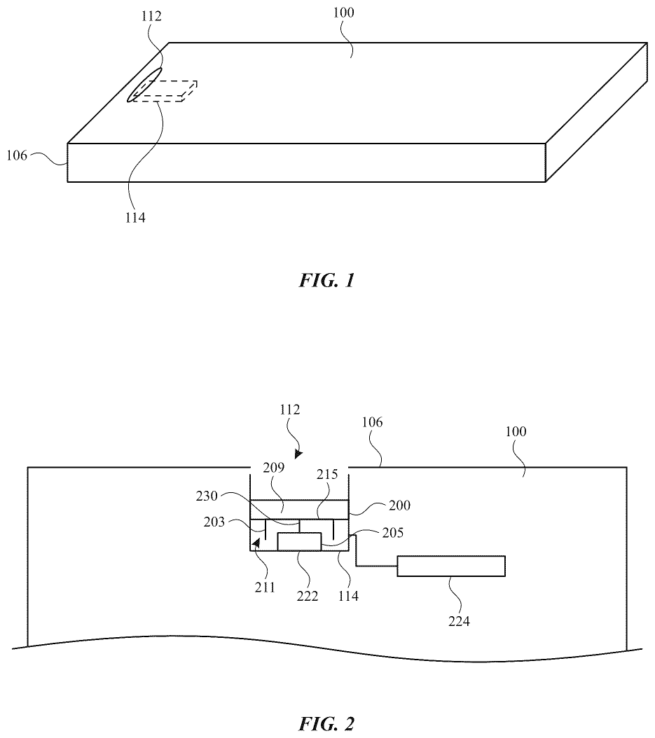

An illustrative electronic device including an audio transducer, such as a speaker, is shown in FIG. 1. In the example of FIG. 1, electronic device 100 has been implemented using a housing 106. In one or more implementations, the housing 106 may be sufficiently small to be portable and carried or worn by a user (e.g., electronic device 100 of FIG. 1 may be a handheld electronic device such as a tablet computer, a laptop computer, a portable wireless speaker, a cellular telephone or smartphone, or a wearable device such as a smart watch or a head mountable device (HMD), a pendant device, or the like). In one or more other implementations, the housing 106 may be configured to rest on a table, a shelf, a desk, a counter, or a floor or to be mounted to a wall (e.g., electronic device 100 of FIG. 1 may be a smart speaker, a desktop computer, a television, a wireless speaker, a gaming console, or the like).

In the example of FIG. 1, housing 106 includes an opening 112. For example, opening 112 may form a port for an audio component. In the example of FIG. 1, the opening 112 forms a speaker port for a speaker 114 disposed within the housing 106. In this example, the speaker 114 is mounted directly adjacent to the opening 112. In one or more other implementations, the speaker 114 may be offset from the opening 112, and sound from the speaker may be routed to and through the opening 112 by one or more internal device structures.

In various implementations, the housing 106 may also include other openings, such as openings for one or more other speakers, one or more microphones, one or more pressure sensors, other sensors, one or more light sources, or other components that receive or provide signals from or to the environment external to the housing 106. Openings such as opening 112 may be open ports, or may be completely or partially covered with a permeable membrane or a mesh structure that allows air and/or sound to pass through. Although one opening 112 and one speaker 114 are shown in FIG. 1, this is merely illustrative. One opening 112, two openings 112, or more than two openings 112 may be provided in the housing 106, and/or two or more speakers 114 may be provided within the housing 106. In some implementations, one or more groups of openings in housing 106 may be aligned with a single port of an audio component within housing 106. Housing 106, which may sometimes be referred to as a case, may be formed of plastic, glass, ceramics, fiber composites, metal (e.g., stainless steel, aluminum, etc.), other suitable materials, or a combination of any two or more of these materials. In various implementations, the housing 106 may be formed from metal, glass, plastic, and/or other materials. The opening(s) 112 may be formed in a metal portion of the housing, a glass portion of the housing (e.g., a glass layer of a display), or any other portion of the housing.

The configuration of electronic device 100 of FIG. 1 is merely illustrative. In various implementations, electronic device 100 may be a computer such as a computer that is integrated into a display such as a computer monitor, a laptop computer, a media player, a gaming device, a navigation device, a computer monitor, a television, a headphone, an earbud, or other electronic equipment. As discussed herein, in some implementations, electronic device 100 may be provided in the form of a laptop computer or a smart speaker. In one or more implementations, housing 106 may include one or more interfaces for mechanically coupling housing 106 to a strap or other structure for securing housing 106 to a wearer.

In one or more implementations, electronic device 100 may also include a display (not shown) mounted to or within the housing 106. Electronic device 100 may include one or more input/output devices such as a touch screen incorporated into display, a button, a switch, a dial, a crown, and/or other input output components disposed on or behind the housing, the display. Housing 106 and/or a display may include one or more openings to accommodate a button, a speaker, a light source, or a camera (as examples).

FIG. 2 illustrates a cross-sectional side view of a portion of the electronic device 100 including a speaker 114. In this example, the speaker 114 may include a front volume 209 and a back volume 211. The front volume 209 and the back volume 211 may be separated by a sound-generating component 215 (e.g., a diaphragm, membrane, dome, stiffener, or an actuatable component of a microelectromechanical systems (MEMS) speaker). The front volume 209 may be fluidly and acoustically coupled to the opening 112 in the housing 106. The front volume 209 and/or the back volume 211 may be formed, in whole or in part by a speaker housing 200. In the example of FIG. 2, the speaker housing 200 is disposed within the housing 106 of the electronic device 100. In one or more other implementations, the housing 106 may form part or all of the speaker housing for the speaker 114. In one or more implementations, the back volume 211 may be a sealed back volume that is bounded, in part, by the speaker housing 200 and/or the sound-generating component 215.

In the example of FIG. 2, the speaker 114 includes speaker circuitry 222. The speaker circuitry may include, for example, a voice coil 203, a fixed magnet 205, and/or other speaker circuitry. In one or more implementations, the electronic device 100 may also include other circuitry, such as device circuitry 224. Device circuitry 224 may include one or more processors, memory, acoustic components, haptic components, mechanical components, electronic components, or any other suitable components of an electronic device. In one or more implementations, the device circuitry 224 may also include one or more sensors, such as an inertial sensor (e.g., one or more accelerometers, gyroscopes, and/or magnetometers), a heart rate sensor, a blood oxygen sensor, a positioning sensor, a microphone, and/or the like. In one or more implementations, device circuitry 224 may generate, based on audio content to be output by the speaker 114, a drive signal for the speaker 114 (e.g., a drive current through the voice coil 203). The current through the voice coil 203 may generate a variable magnetic field that interacts with the fixed magnet 205 to cause the voice coil 203, and resultingly the sound-generating component 215 to move to generate sound corresponding to the audio content.

As shown in FIG. 2, in one or more implementations, the speaker 114 may be provided with a spring 230. As discussed in further detail hereinafter, the spring 230 may be biased against the sound-generating component 215 (e.g., biased between the speaker housing 200 and the sound-generating component 215 and/or between the fixed magnet 205 and the sound-generating component 215) to mitigate a stiffness (e.g., also referred to herein as a speaker stiffness) generated by trapped air within the back volume 211. As discussed in further detail hereinafter, the spring 230 may be disposed at or near a center of the speaker (e.g., in a cavity in at or near the center of a center magnet of the speaker). In one or more implementations, the spring 230 may be formed from a non-magnetic material (e.g., plastic and/or a non-magnetic metal such as aluminum) to avoid affecting the magnetic field generated by the fixed magnet 205 and/or by a current flowing through the voice coil 203.

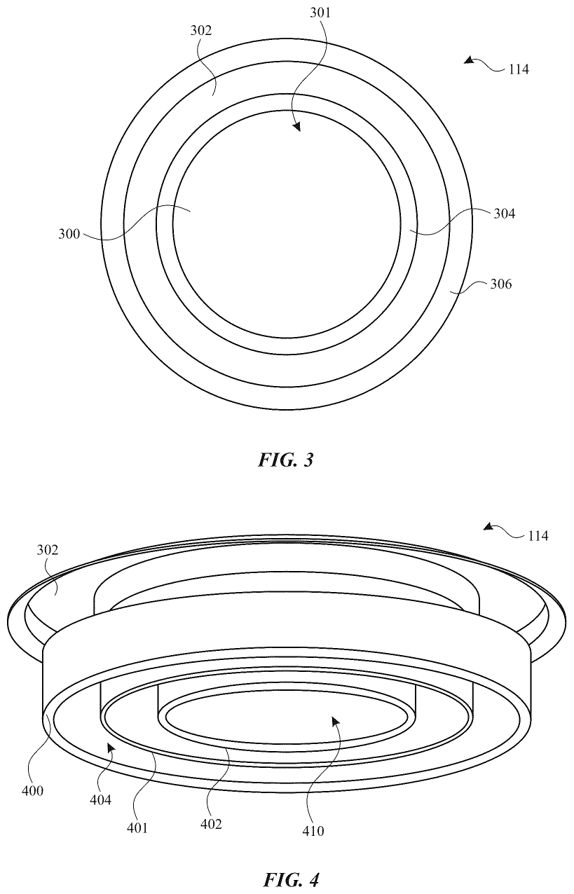

FIG. 3 illustrates a top view of an example speaker assembly for speaker 114, in accordance with one or more implementations. As shown in FIG. 3, the speaker 114 may include a diaphragm 301 (e.g., an implementation of the sound-generating component 215). Speaker 114 may also include a surround 302 that extends around a periphery of diaphragm 301 and that movably suspends the diaphragm 301. In one or more implementations, diaphragm 301 may include a dome portion 300 and a neck portion 304 that extends around a periphery of the dome portion 300. In one or more implementations, the surround 302 may extend from the diaphragm 301 (e.g., from the neck portion 304) to a support structure such as support structure 306. Support structure 306 may be a fixed support structure (e.g., fixed to and/or relative to other portions of the speaker assembly, such as a speaker frame or a speaker housing, and/or fixed to and/or relative to other portions or components of the device in which the speaker is implemented). The surround 302 may be formed from a flexibly resilient material that movably suspends the diaphragm 301 with respect to other components of the speaker, such as a support structure 306 and/or one or more fixed magnets.

FIG. 4 illustrates a bottom perspective view of the speaker 114. As shown in FIG. 4, the speaker 114 may include a magnet 400 (e.g., a first fixed magnet, such as an outer magnet) and a magnet 402 (e.g., a second fixed magnet, such as a center magnet). In one or more implementations, the magnet 402 may be an implementation of the fixed magnet 205 of FIG. 2. As shown, the magnet 400 and the magnet 402 may be separated by a gap 404 within which a voice coil 401 (e.g., an implementation of the voice coil 203 of FIG. 2) is disposed and can move. In the configuration of FIG. 4, when a current is provided through the voice coil 401, a resulting magnetic field interacts with the magnet 400 and the magnet 402 to move the voice coil 401, and resultingly, the diaphragm 301 that is attached to the voice coil 401. The magnet 400 and the magnet 402 may be two separate magnets, or may be portions of a single (e.g., contiguous magnet) having a gap 404 between the two portions.

As shown in FIG. 4, the magnet 402 may be a center magnet, and the voice coil 203 may extend around the center magnet. As shown in FIG. 4, in one or more implementations, the magnet 402 may include a cavity 410. As discussed in further detail hereinafter, the cavity 410 may be a through hole that passes entirely through the magnet 402 or may be a pocket (e.g., a machined pocket) that extends only partway into the magnet 402. In one or more other implementations, the magnet 402 may be formed from multiple magnet segments (e.g., multiple bar magnets) that are separated by a gap that forms the cavity 410.

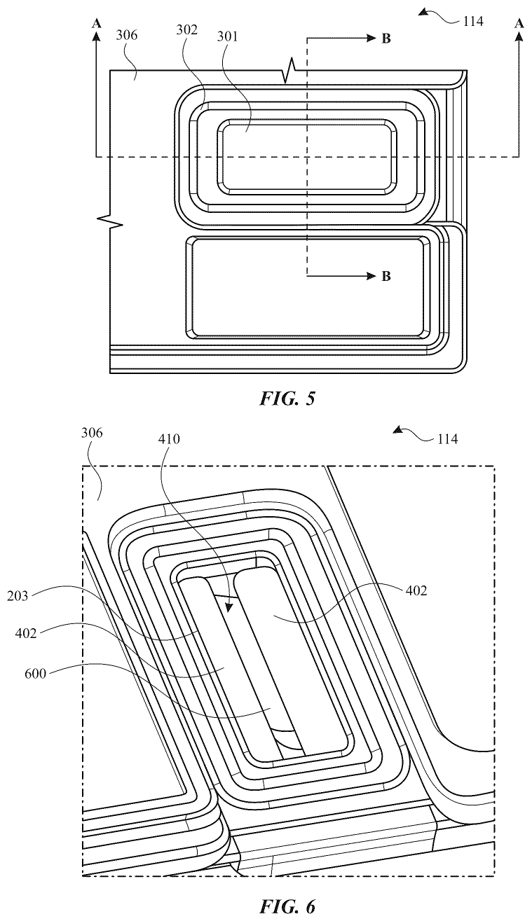

In the example of FIG. 4, the magnet 400, the magnet 402, and the support structure 306 are substantially cylindrical, each having (e.g., along with the dome portion 300 and the surround 302) a substantially circular cross section. However, this is merely illustrative, and the magnet 400, the magnet 402, the diaphragm 301, the dome portion 300, the surround 302, and the support structure 306 may have other form factors, including form factors with substantially rectangular, square, or oval cross sections. For example, FIG. 5 illustrates top view of the speaker 114 in an implementation in which the diaphragm 301, the surround 302, and the support structure 306 each have a substantially rectangular shape. FIG. 6 illustrates a perspective top view of the speaker 114 in the implementation of FIG. 5, with the diaphragm 301 and the surround 302 removed so that the voice coil 203, the magnet 402, and the cavity 410 can be seen. In the example of FIG. 6, the magnet 402 is formed from a pair of magnet segments (e.g., bar magnets) that are separated by an air gap that forms the cavity 410. In the example of FIG. 6, a portion of a yoke 600 of the speaker 114 can be seen through the cavity 410. For example, the yoke 600 may be a structural component of the speaker 114, and may support the magnet 402 and/or one or more other components of the speaker 114.

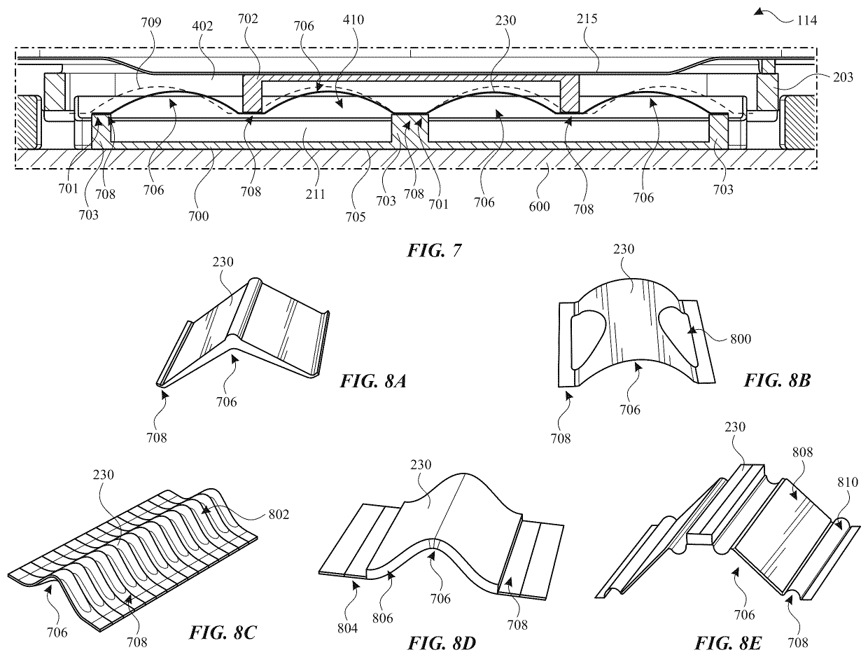

FIG. 7 illustrates a cross-sectional side view of the speaker 114 in the implementation of FIGS. 5 and 6, with the cross-section taken along line A-A of FIG. 5. In the example of FIG. 7, the speaker 114 includes a spring 230 that is disposed within the cavity 410. In the example of FIG. 7, the spring 230 is mounted on a support structure 700. For example, the support structure 700 may mount a base (e.g., base portion 701) of the spring 230 to a structural component, such as the yoke 600, of the speaker 114. For example, the support structure 700 may include one or more posts 703 that extend upward from a base portion 705 of the support structure 700. As shown, one or more base portions of the spring 230 may be mounted, respectively, to the one or more posts 703. In this example, the base portion 705 is mounted within and extends along an elongate dimension of the cavity 410 (e.g., along the direction of the cross-section shown in FIG. 7). As shown, one or more additional base portions of the spring 230 may be suspended within the cavity 410 (e.g., without landing on a post 703 of the support structure 700).

As shown in FIG. 7 the speaker 114 may also include a bridge structure 702. For example, the bridge structure 702 may mechanically couple the spring 230 to the sound-generating component 215 (e.g., to transfer a force of the spring to the sound-generating component). It is appreciated that the example of FIG. 7, in which the spring 230 is mounted to the yoke 600 by the support structure 700, and to the sound-generating component 215 by the bridge structure 702, is merely illustrative. In one or more other implementations, the spring 230 within the cavity 410 may be mounted directly to the yoke 600 (and/or another structure and/or component of the speaker 114), and/or directly to the sound-generating component 215. For example, in one or more implementations, the yoke 600 and/or the sound-generating component 215 may be overmolded onto a portion of the spring 230. In one or more implementations, the support structure 700 may be formed as part of the yoke 600. In one or more other implementations, the bridge structure 702 may be formed as a part (e.g., a protrusion or an extension) of the sound-generating component 215. In one or more implementations, the support structure 700 and/or the bridge structure 702 may be formed from a non-magnetic material, such as plastic and/or aluminum.

The example of FIG. 7 includes a dashed line 709 that indicates an uncompressed shape of the spring 230 (e.g., prior to implementation in the speaker 114). As shown, in the uncompressed shape indicated by the dashed line 709, the spring 230 is wider that than in the shape of the spring 230 installed in the speaker 114. For example, the spring 230 may be pre-compressed (e.g., upon installation into the speaker 114), so as to bias the spring 230 (e.g., within a predetermined initial force) against (e.g., directly or via the bridge structure 702) the sound-generating component 215. In this way, the spring 230 can be configured to push outward (e.g., away from the back volume 211) on the sound-generating component, to mitigate an (e.g., opposite) spring force generated by trapped air within the back volume 211.

As shown in FIG. 7, in one or more implementations, the spring 230 may include multiple spring sections, each having a central portion 706 and an outer portion 708 (e.g., a base portion 701). In the example of FIG. 7, the spring 230 includes four spring sections. However, this is merely illustrative, and more or fewer than four spring sections can be included. In various examples, the spring sections can be separate springs that are attached together, or can be sections of a contiguous spring structure. For example, the spring sections may be thermoformed together for improved consistency of the performance of the spring 230. In one or more implementations, the central portion 706 of each of the spring sections may be relatively stiffer than the outer portion 708 of that spring section.

FIGS. 8A-8E illustrate various example implementations of the spring sections of the spring 230 of FIG. 7. As shown, the spring sections may take the form of a door-hinge spring having a central portion 706 that is relatively thicker than an outer portion 708 as shown in FIG. 8A, a thermoformed spring with cutouts 800 as shown in FIG. 8B, a corrugated spring having a central portion 706 with corrugations 802 that stiffen the central portion relative to the outer portion 708 as shown in FIG. 8C, a multi-layer spring having multiple layers (e.g., a first layer 804 that extends from a first end to a second end of the spring, and a second layer 806 formed on the first layer and extending over only the central portion 706) as shown in FIG. 8D, and/or a butterfly spring having straight sections 808 in the central portion 706 concave/convex sections 810 at the outer portions 708 as shown in FIG. 8E. In the examples of FIGS. 8A, 8B, 8C, and 8D, the central portion 706 is a thicker portion of the spring, which is the part of the spring which has the function to generate the reaction force that counters the stiffness of the speaker 114. However, in the example of FIG. 8E, the central portion 706 portion of the spring may be arranged to constrain the deformation of the middle section between the two corrugations (e.g., the concave/convex sections 810). In the example of FIG. 8E, the outer portions 708 provide the reaction force for the spring. For example, the operation principle of spring 230 in FIG. 8E may reverse the central portion 706 functionality swapped with the that of the outer portion 708 (e.g., relative to the springs of FIGS. 8A, 8B, 8C, and 8D), such as to improve the stress/fatigue control for the spring 230. In various implementations, any of the springs of FIGS. 8A-8E may form any of the spring sections of the multi-section spring of FIG. 7, or any other implementation of the spring 230 discussed herein.

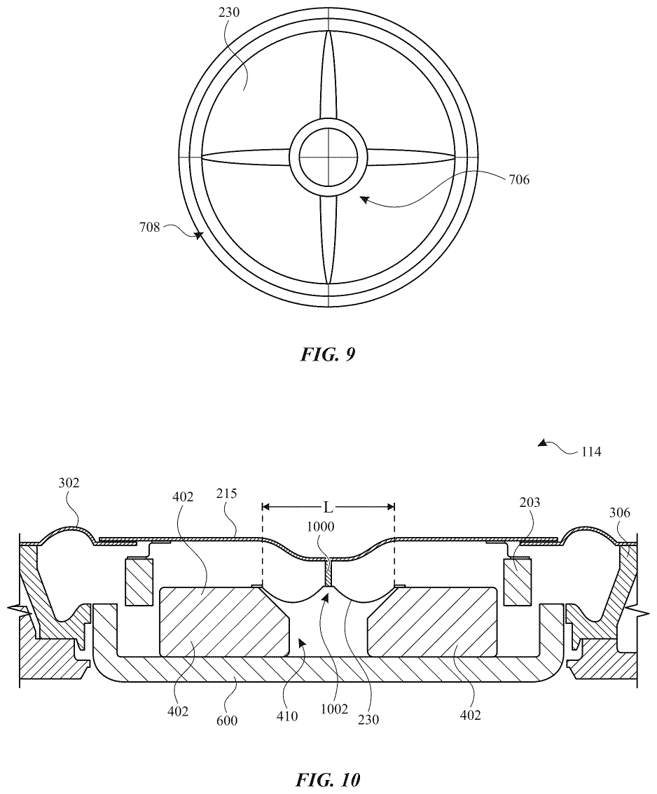

In one or more other implementations, the multi-section spring of FIG. 7 may be replaced with a circular spring as shown in FIG. 9. In the example of FIG. 9, the outer portion 708 of the spring 230 has a (e.g., substantially) circular outer periphery, and the central portion 706 of the spring 230 is formed by a resiliently compressible domed structure extending radially inward from the outer portion 708. In various implementations, the outer portion 708 of the spring 230 in the implementation of FIG. 9 may be mounted to a (e.g., circular) post 703 of a support structure 700, to the yoke 600, or to the magnet 402 (as examples), and the center portion of the domed structure may be mounted (e.g., directly or via a bridge structure 702) to the sound-generating component 215.

FIG. 10 illustrates another cross-sectional side view of the speaker 114 in the implementation of FIGS. 5 and 6, with the cross-section taken along line B-B of FIG. 5, and the spring 230 mounted to the magnet 402 (e.g., rather than to the yoke 600 or a support structure 700). In the example of FIG. 10, the cross section extends across (e.g., perpendicular to) the elongate dimension of the cavity 410 (e.g., rather than along the elongate dimension of the cavity 410, as in the example of FIG. 7). In the example of FIG. 10, the speaker 114 includes a spring 230 that is mounted to the magnet 402 and is disposed partially within the cavity 410. In the example of FIG. 10, the spring orientation is rotated (e.g., ninety degrees) and flipped (e.g., one hundred eighty degrees) with respect to the spring 230 in the implementation of FIG. 7. In the example of FIG. 10, the spring 230 includes two spring sections. In the example of FIG. 10, the speaker 114 includes a bridge structure 1000 that mechanically couples a suspended base portion 1002 of the spring 230 to the sound-generating component 215. For example, the bridge structure may be a separate structure that is attached between the spring 230 and the sound-generating component 215. However, this is merely illustrative, and, in one or more other implementations, the spring 230 may be mounted directly to the sound-generating component 215, the bridge structure 1000 may be formed as an integral portion (e.g., a protrusion or an extension) of the sound-generating component 215, and/or the bridge structure 1000 may be an integral portion (e.g., an extension or protrusion) of the spring 230.

In the example of FIG. 10, the spring 230 may be pre-compressed into the shape shown in FIG. 10 between the magnet 402 and the sound-generating component 215, and attached (e.g., adhesively) to the magnet 402 and (e.g., directly or via the bridge structure 1000) to the sound-generating component. In this way, the spring may be biased against the sound-generating component 215 (e.g., biased between the magnet 402 and the sound-generating component 215) to press outward (e.g., away from the back volume 211) on the sound-generating component 215, to mitigate an (e.g., opposite) spring force generated by trapped air within the back volume 211.

In the example of FIG. 10, each of the spring sections may take the form of any of the examples of FIGS. 8A-8E, and may have a central portion that is relatively stiffer than an outer portion (e.g., including an outer portion that mounts, such as adhesively, to the magnet 402). In the example of FIG. 10, the spring 230 may have a length, L, (e.g., in a direction extending across the elongate dimension of the cavity 410) of less than twenty millimeters (mm), less than fifteen millimeters, or less than ten millimeters (e.g., between five mm and nine mm), as examples. In the example of FIG. 10, the spring 230 may have a width (e.g., in a direction along the elongate dimension of the cavity 410) of less than eighty mm, less than fifty mm, less than forty mm, or less than thirty mm (e.g., between thirty-five and forty-five mm), as examples.

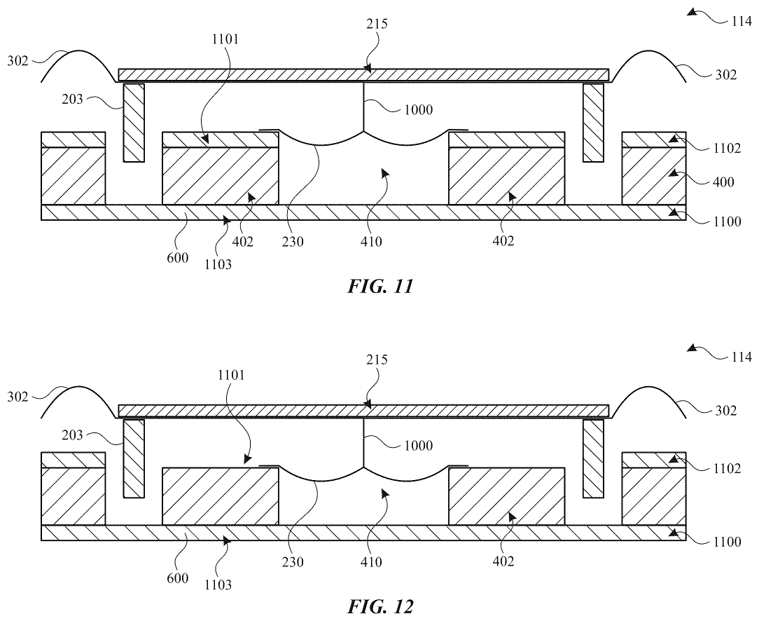

In the example of FIG. 10, the spring 230 is mounted directly to the magnet 402. However, in other implementations, a spring having the shape and orientation of the spring 230 of FIG. 10 may be mounted to one or more other structures of the speaker. For example, FIG. 11 illustrates an implementation of the speaker 114 in which a metal layer 1102 (e.g., a non-magnetic metal, such as a low carbon steel) is provided on a first surface 1101 (e.g., a top surface) of the magnets 400 and 402, and a metal layer 1100 (e.g., a non-magnetic metal, such as a low carbon steel) is provided on a second surface 1103 (e.g., a bottom surface) of the magnets 400 and 402. In this example, the spring 230 may be mounted to (attached to, such as using an adhesive) the metal layer 1102 that is disposed on the magnet 402 (e.g., on the first surface 1101).

In the examples of FIGS. 4, 6, 7, 10, and 11, the cavity 410 extends all the way through the magnet 402 (e.g., from the first surface 1101 to the second surface 1103, such as by forming a through hole a single magnet, or by providing multiple magnet segments, such as bar magnets, spaced apart by an air gap that forms the cavity 410). In one or more other implementations, the cavity 410 may be formed from a pocket in the magnet 402 that extends only partway into the magnet 402. For example, FIG. 12 illustrates a cross-sectional view of the speaker 114 of FIG. 5, with the cross section taken along the line B-B of FIG. 5, in an implementation in which the cavity 410 is formed by a pocket (e.g., a machined pocket) in the magnet 402. In this example, the cavity 410 extends only partway into the magnet 402 (e.g., only partway between the first surface 1101 and the second surface 1103). In the example of FIG. 12, the metal layer 1102 is omitted or removed from at least a portion of the first surface 1101 (e.g., top surface) of the magnet 402 (e.g., while being present on the top surface of the magnet 400), and the spring 230 is mounted directly to the first surface 1101. However, in other implementations, the metal layer 1102 may be provided on the first surface 1101 of the magnet 402, and the pocket that forms the cavity 410 may be formed from a through-hole in the metal layer 1102 that is aligned with a pocket (e.g., as shown in FIG. 12) in the magnet 402.

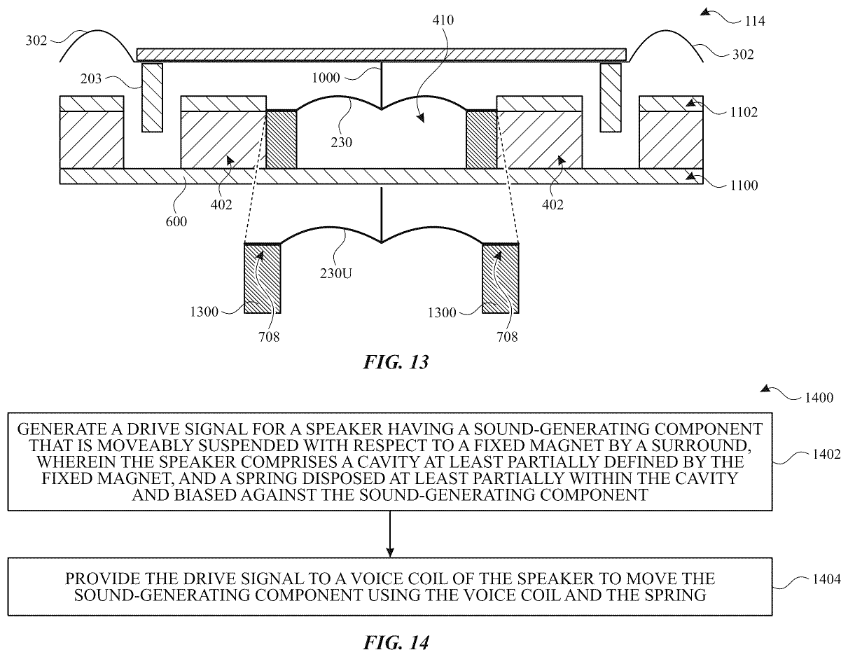

In the examples of FIGS. 10-12, the spring 230 that extends across (e.g., rather than along) an elongate dimension of the cavity 410 is attached to the magnet 402 and/or a metal layer 1102 thereon. FIG. 13 illustrates another example implementation of the speaker 114 in which the spring 230 is mounted to one or more support structures 1300 and compressed into the cavity 410. For example, FIG. 13 illustrates an uncompressed spring 230U having opposing outer portions 708 mounted to respective support structures 1300. As indicated by the dashed lines in the figure, the support structures 1300 may be pressed toward each other to pre-compress the spring 230 and to fit within the cavity 410, and may be held in a compressed configuration by the inner edges of the magnet 402 that form the cavity 410.

In the examples of FIGS. 6-13, a spring 230 is provided at least partially within an opening or cavity (e.g., cavity 410) within a magnet of a speaker. In these examples, the opening or cavity is located at or around a central portion of a central magnet (e.g., a magnet that is positioned interior to the bore formed by the voice coil), which may be beneficial for the operation of the speaker. In, for example, implementations in which a voice coil 203 of the speaker extends around the center magnet having the opening or cavity at or around the center thereof, the impact to speaker performance of reduced magnet size (e.g., due to the presence of the opening or cavity) may be limited (e.g., because the central portion of the magnet contributes less to the operation of the speaker), allowing the stiffness mitigation of the spring disposed therein to outweigh any effect of the opening or cavity on the operation of the speaker.

As illustrated by various aspects of FIGS. 1-13, in one or more implementations, an audio transducer (e.g., speaker 114) may include a fixed magnet (e.g., fixed magnet 205 and/or magnet 402), a sound-generating component (e.g., a sound-generating component 215, such as a diaphragm 301) that is moveably suspended with respect to the fixed magnet by a surround (e.g., a surround 302), a cavity (e.g., cavity 410) at least partially defined by the fixed magnet, and a spring (e.g., spring 230) disposed at least partially within the cavity and biased against the sound-generating component. For example, the spring may be disposed in a back volume (e.g., back volume 211) of the audio transducer. For example, the spring may mitigate at least some of a stiffness generated by air in a back volume of the audio transducer.

The fixed magnet may be or include a center magnet, and the audio transducer may also include a voice coil (e.g., voice coil 203) that is mechanically coupled to the sound-generating component and extends around the center magnet (e.g., as shown in FIGS. 4, 6, 7, 10, 11, 12, and/or 13). The cavity may be formed around a center of the center magnet. In one or more implementations, the cavity may include a through-hole in the center magnet (e.g., as shown in FIGS. 4, 6, 7, 10, 11, and/or 13). In one or more implementations, the cavity may include a pocket in the center magnet (e.g., as shown in FIG. 12). In one or more implementations, the cavity may include a space between multiple magnet segments that form the fixed magnet (e.g., as in the example of FIG. 6).

In one or more implementations, a base (e.g., a base portion 701, such as an outer portion 708) of the spring may be mounted, within the cavity, to a structural component (e.g., yoke 600) of the audio transducer, and biased between the structural component and the sound-generating component (e.g., as shown in FIG. 7). For example, the structural component may be a yoke (e.g., yoke 600) of the audio transducer. In one or more implementations, the audio transducer may also include a support structure (e.g., support structure 700) that mounts the base of the spring to the structural component. In one or more implementations, the audio transducer may also include a bridge structure (e.g., bridge structure 702) that mechanically couples the spring to the sound-generating component. In one or more implementations, the spring may include a plurality of (e.g., two or four) spring sections, each having a central portion (e.g., central portion 706) and an outer portion (e.g., outer portion 708). The central portion of each of the spring sections may be relatively stiffer than the outer portion of that spring section.

In one or more implementations, the spring may be mounted to the fixed magnet and biased between the fixed magnet and the sound-generating component (e.g., as shown in the examples of FIGS. 10, 11, 12, and/or 13). For example, the spring may be mounted directly to the fixed magnet (e.g., as in the examples of FIGS. 10 and 12). As another example, the spring may be mounted to a metal layer (e.g., metal layer 1102) disposed on the fixed magnet (e.g., as in the example of FIG. 11). In one or more implementations, the spring may be mounted to a support structure (e.g., support structure 1300) and compressed between surfaces of the fixed magnet that define opposing sides (e.g., internal surfaces) of the cavity (e.g., as shown in the example of FIG. 13).

In one or more implementations, the cavity may be an elongate cavity, and the spring may include an elongate dimension that extends along an elongate dimension (e.g., along the direction of the cross-section A-A of FIG. 5, and as is visible in FIGS. 6 and 7) of the elongate cavity. In one or more implementations, the elongate dimension may be less than fifty millimeters long.

As illustrated by FIGS. 1-13, in one or more implementations, an electronic device (e.g., electronic device 100) may include a microspeaker (e.g., speaker 114) that includes a fixed magnet (e.g., fixed magnet 205, such as magnet 402), a sound-generating component (e.g., a sound-generating component 215, such as a diaphragm 301) that is moveably suspended with respect to the fixed magnet by a surround (e.g., surround 302), a cavity (e.g., cavity 410) at least partially defined by the fixed magnet, and a spring (e.g., spring 230) disposed at least partially within the cavity and biased against the sound-generating component.

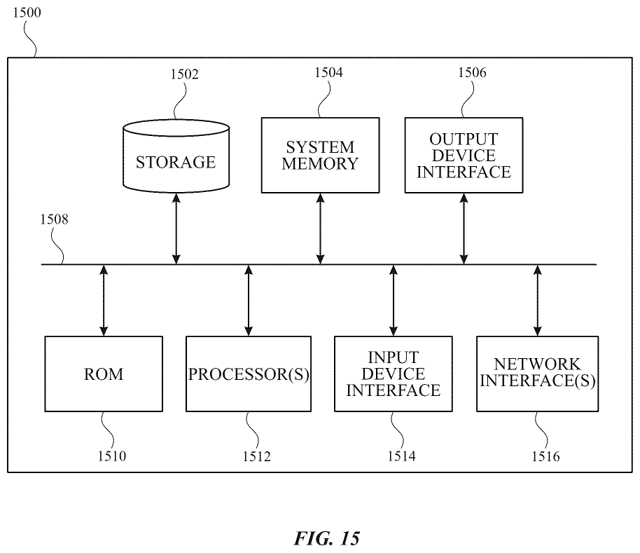

FIG. 14 illustrates a flow diagram of an example process for operating an audio transducer such a speaker, in accordance with one or more implementations. For explanatory purposes, the process 1400 is primarily described herein with reference to the electronic device 100 and the speaker 114 of FIGS. 1-13. However, the process 1400 is not limited to the electronic device 100 and the speaker 114 of FIGS. 1-13, and one or more blocks (or operations) of the process 1400 may be performed by one or more other components and other suitable audio transducers. Further for explanatory purposes, the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

In the example of FIG. 14, at block 1402, a drive signal (e.g., a drive current) may be generated (e.g., by an electronic device, such as the electronic device 100, in which a speaker is disposed) for a speaker (e.g., a speaker 114) having a sound-generating component (e.g., sound-generating component 215, such as a diaphragm, a dome, a membrane, and/or a stiffener), that is moveably suspended (e.g., by a surround, such as surround 302) with respect to a fixed magnet (e.g., fixed magnet 205 and/or magnet 402) by a surround. The speaker may include a cavity (e.g., cavity 410) at least partially defined by the fixed magnet, and a spring (e.g., spring 230 as described herein in connection with any of FIGS. 2, 7, 8, 9, 10, 11, 12, and/or 13) disposed at least partially within the cavity and biased against the sound-generating component.

At block 1404, the drive signal may be provided to a voice coil (e.g., voice coil 203) of the speaker to move the sound-generating component using the voice coil and the spring. For example, moving the sound-generating component using the voice coil and the spring may include moving the sound-generating component with a magnetic interaction between the fixed magnet and a magnetic field generated by the drive current flowing through the voice coil, aided by a biasing force of the spring (e.g., to mitigate a stiffness caused by trapped air in a back volume of the speaker).

FIG. 15 illustrates an electronic system 1500 with which one or more implementations of the subject technology may be implemented. The electronic system 1500 can be, and/or can be a part of, one or more of the electronic device 100 shown in FIG. 1. The electronic system 1500 may include various types of computer readable media and interfaces for various other types of computer readable media. The electronic system 1500 includes a bus 1508, one or more processing unit(s) 1512, a system memory 1504 (and/or buffer), a ROM 1510, a permanent storage device 1502, an input device interface 1514, an output device interface 1506, and one or more network interfaces 1516, or subsets and variations thereof.

The bus 1508 collectively represents all system, peripheral, and chipset buses that communicatively connect the numerous internal devices of the electronic system 1500. In one or more implementations, the bus 1508 communicatively connects the one or more processing unit(s) 1512 with the ROM 1510, the system memory 1504, and the permanent storage device 1502. From these various memory units, the one or more processing unit(s) 1512 retrieves instructions to execute and data to process in order to execute the processes of the subject disclosure. The one or more processing unit(s) 1512 can be a single processor or a multi-core processor in different implementations.

The ROM 1510 stores static data and instructions that are needed by the one or more processing unit(s) 1512 and other modules of the electronic system 1500. The permanent storage device 1502, on the other hand, may be a read-and-write memory device. The permanent storage device 1502 may be a non-volatile memory unit that stores instructions and data even when the electronic system 1500 is off. In one or more implementations, a mass-storage device (such as a magnetic or optical disk and its corresponding disk drive) may be used as the permanent storage device 1502.

In one or more implementations, a removable storage device (such as a floppy disk, flash drive, and its corresponding disk drive) may be used as the permanent storage device 1502. Like the permanent storage device 1502, the system memory 1504 may be a read-and-write memory device. However, unlike the permanent storage device 1502, the system memory 1504 may be a volatile read-and-write memory, such as random access memory. The system memory 1504 may store any of the instructions and data that one or more processing unit(s) 1512 may need at runtime. In one or more implementations, the processes of the subject disclosure are stored in the system memory 1504, the permanent storage device 1502, and/or the ROM 1510. From these various memory units, the one or more processing unit(s) 1512 retrieves instructions to execute and data to process in order to execute the processes of one or more implementations.

The bus 1508 also connects to the input and output device interfaces 1514 and 1506. The input device interface 1514 enables a user to communicate information and select commands to the electronic system 1500. Input devices that may be used with the input device interface 1514 may include, for example, microphones, alphanumeric keyboards and pointing devices (also called “cursor control devices”). The output device interface 1506 may enable, for example, the display of images generated by electronic system 1500. Output devices that may be used with the output device interface 1506 may include, for example, printers and display devices, such as a liquid crystal display (LCD), a light emitting diode (LED) display, an organic light emitting diode (OLED) display, a flexible display, a flat panel display, a solid state display, a projector, a speaker or speaker module, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 15, the bus 1508 also couples the electronic system 1500 to one or more networks and/or to one or more network nodes through the one or more network interface(s) 1516. In this manner, the electronic system 1500 can be a part of a network of computers (such as a LAN, a wide area network (“WAN”), or an Intranet, or a network of networks, such as the Internet. Any or all components of the electronic system 1500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An audio transducer, comprising:
a fixed magnet;
a sound-generating component that is moveably suspended with respect to the fixed magnet by a surround;
a cavity at least partially defined by the fixed magnet; and
a spring disposed at least partially within the cavity and biased against the sound-generating component.

2. The audio transducer of claim 1, wherein the fixed magnet comprises a center magnet, and wherein the audio transducer further comprises a voice coil that is mechanically coupled to the sound-generating component and extends around the center magnet.

3. The audio transducer of claim 2, wherein the cavity is formed around a center of the center magnet.

4. The audio transducer of claim 3, wherein the cavity comprises a through-hole in the center magnet.

5. The audio transducer of claim 3, wherein the cavity comprises a pocket in the center magnet.

6. The audio transducer of claim 3, wherein the cavity comprises a space between multiple magnet segments that form the fixed magnet.

7. The audio transducer of claim 1, wherein a base of the spring is:
mounted, within the cavity, to a structural component of the audio transducer, and
biased between the structural component and the sound-generating component.

8. The audio transducer of claim 7, wherein the structural component comprises a yoke of the audio transducer.

9. The audio transducer of claim 7, further comprising a support structure that mounts the base of the spring to the structural component.

10. The audio transducer of claim 9, further comprising a bridge structure that mechanically couples the spring to the sound-generating component.

11. The audio transducer of claim 10, wherein the spring comprises a plurality of spring sections, each having a central portion and an outer portion, wherein the central portion of each of the spring sections is relatively stiffer than the outer portion of that spring section.

12. The audio transducer of claim 1, wherein the spring is mounted to the fixed magnet and biased between the fixed magnet and the sound-generating component.

13. The audio transducer of claim 12, wherein the spring is mounted directly to the fixed magnet.

14. The audio transducer of claim 12, wherein the spring is mounted to a metal layer disposed on the fixed magnet.

15. The audio transducer of claim 1, wherein the cavity is an elongate cavity, and wherein the spring comprises an elongate dimension that extends along an elongate dimension of the elongate cavity.

16. The audio transducer of claim 15, wherein the elongate dimension is less than fifty millimeters long.

17. The audio transducer of claim 1, wherein the spring is disposed in a back volume of the audio transducer.

18. The audio transducer of claim 1, wherein the spring mitigates at least some of a stiffness generated by air in a back volume of the audio transducer.

19. The audio transducer of claim 1, wherein the spring is mounted to a support structure and compressed between surfaces of the fixed magnet that define opposing sides of the cavity.

20. An electronic device, comprising:
a microspeaker, comprising:
a fixed magnet;
a sound-generating component that is moveably suspended with respect to the fixed magnet by a surround;
a cavity at least partially defined by the fixed magnet; and
a spring disposed at least partially within the cavity and biased against the sound-generating component.

21. A method, comprising:
generating a drive signal for a speaker having a sound-generating component that is moveably suspended with respect to a fixed magnet by a surround, wherein the speaker comprises a cavity at least partially defined by the fixed magnet, and a spring disposed at least partially within the cavity and biased against the sound-generating component; and
providing the drive signal to a voice coil of the speaker to move the sound-generating component using the voice coil and the spring.
